(19) United States
(12) Patent Application Publication
(10) Pub. No.: US 2006/0155557 A1
(43) Pub. Date: Jul. 13, 2006

(54) Customized one time use vapor deposition source

(75) Inventors: Dennis R. Freeman, Spencerport, NY (US); Neil P. Redden, Sodus Point, NY (US); Terrence R. O'Toole, Webster, NY (US)

Correspondence Address: Pamela R. Crocker;Eastman Kodak Company, Patent Legal Staff, 343 State Street, Rochester, NY, 14650-2201, US

(73) Assignee: Eastman Kodak Company

(21) Appl. No.: 11/032,982

(22) Filed: Jan. 11, 2005

(51) Int. Cl. G06Q 99/00; G06Q 30/00

(52) U.S. Cl. 705/1; 705/26

(57) ABSTRACT

A method of providing a customized one time use vapor deposition source to a user includes a supplier receiving an order from the user; the supplier providing the one time use vapor deposition source to the user, wherein the one time use vapor deposition source includes at least a boat containing the organic material, a heating element, and an aperture plate; and the supplier receiving payment for the one time use vapor deposition source.

### CROSS REFERENCE TO RELATED APPLICATIONS

Reference is made to commonly assigned U.S. patent application Ser. No. 10/971,698 filed Oct. 25, 2004, by Dennis R. Freeman, et al., entitled “Elongated Thermal Physical Vapor Deposition Source With Plural Apertures” (a continuation-in-part of U.S. patent application Ser. No. 10/093,739 filed Mar. 8, 2002, now abandoned); commonly assigned U.S. patent application Ser. No. 10/352,558 filed Jan. 28, 2003, by Jeremy M. Grace, et al., entitled “Method of Designing a Thermal Physical Vapor Deposition System”; and commonly assigned U.S. patent application Ser. No. ______ filed concurrently herewith, by Dennis R. Freeman, et al., entitled “Vaporization Source With Baffle”, the disclosures of which are herein incorporated by reference.

### FIELD OF THE INVENTION

The present invention relates to providing customized one time use vapor deposition sources, which have organic material to a user, which are particularly suitable for making devices for use in making OLED devices.

### BACKGROUND OF THE INVENTION

Vapor deposition of organic materials is well known and has been used in the art for many purposes. It is a particularly useful method for coating thin layers of organic materials onto substrates to form electronic devices such as organic thin film transistors (OTFTs), organic light emitting diodes (OLEDs), and many others. In some applications, the materials used in the device are extremely sensitive to contamination such as water and particles. In the case of OLED devices, exposure of organic materials to water vapor can result in greatly reduced efficiency and device lifetime.

Although the moisture sensitivity of OLED devices and materials are well known, it is nevertheless a very common practice for a manufacturer to load a vapor deposition source with organic materials under ambient conditions. For example, a device manufacturer can receive a bottle of organic material. The manufacturer will pour the material into an appropriate part the vapor deposition source. The manufacturer often does not know how much material is needed for the next manufacturing run and can put in too much or too little in unless the material is weighed out. After loading, the vapor deposition source then needs to be assembled. All of these steps are time consuming and result in a significant chance for contamination and errors. This results in large manufacturing cost and waste.

There is a need, therefore, for a manufacturer to reduce manufacturing costs and device defects due to contamination.

### SUMMARY OF THE INVENTION

It is an therefore object of the present invention to provide the use of vapor deposition sources without having to be involved in the process of loading or reconditioning such sources.

This object is achieved by a method of providing a customized one time use vapor deposition source to a user, comprising:

a) a supplier receiving an order from the user;

b) the supplier providing the one time use vapor deposition source to the user, wherein the one time use vapor deposition source includes at least a boat containing the organic material, a heating element, and an aperture plate; and

c) the supplier receiving payment for the one time use vapor deposition source.

### ADVANTAGES

By providing a one time use vapor deposition source, a user does not have to be concerned with reloading such source with organic material thereby reducing manufacturing time and cost. Moreover, a one time use source that is manufactured by a supplier reduces possible contamination risks by the user, especially in the user's attempt to reload or recondition the source. In addition, by reducing the handling of organic material, the reproducibility of the vapor deposition is higher resulting in fewer defective parts.

### BRIEF DESCRIPTION OF THE DRAWINGS

FIG. 1 is a block diagram of a schematic information network that facilitates a user ordering a one time use vapor deposition source and permits payment to be made;

FIG. 2 is a flow diagram showing a process for a purchase transaction for providing a one time use vapor deposition source;

FIG. 3 shows a cross-sectional view of a low cost, one time use vapor deposition source for depositing organic materials in accordance with this invention; and

FIG. 4 shows a top view of the above vapor deposition source.

### DETAILED DESCRIPTION OF THE INVENTION

A one time use vapor deposition source is provided to a user from a supplier and includes at least a boat for containing an organic material to be vaporized, a heater for causing vaporization, and an aperture plate to control the distribution of the vapor. By providing all the necessary elements, the handling of the organic material by the user is reduced, thereby reducing manufacturing costs and reducing contamination risks. The one time use vapor deposition source is not recharged or reused by the user.

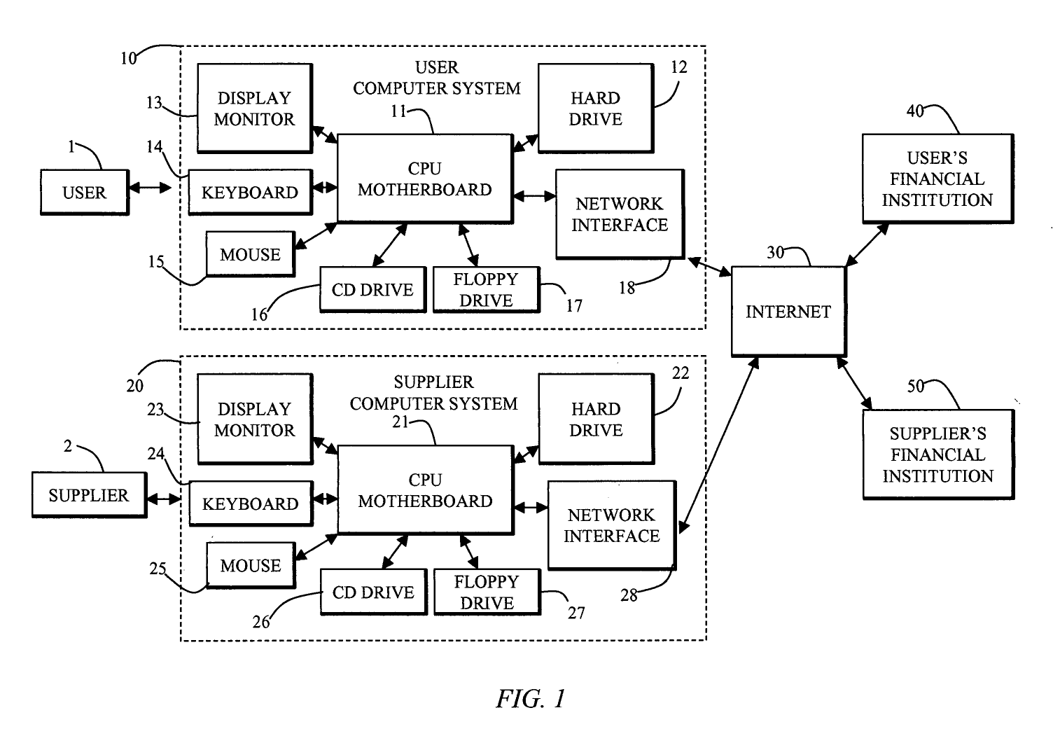

FIG. 1 is a block diagram of a schematic information network that facilitates a user ordering a one time use vapor deposition source and permits payment to be made. The network includes a user computer system 10 that can be located at the user site, e.g., their manufacturing site. The user computer system 10 includes a CPU motherboard 11. The CPU motherboard executes software stored on a hard drive 12. The CPU motherboard is coupled to a display monitor 13, keyboard 14 and a mouse 15, each of which permits the user 1 to readily communicate with the CPU motherboard 11. Other data drives such as a CD drive 16 and floppy drive 17 can be used to store data that can be accessed by the CUP motherboard 11. The user computer system 10 is also provided with a network interface 18 for communicating with the Internet 30, for example, by a dial-in modem or a broadband connection. In this discussion, the Internet includes Internet service providers, computers, routers, and other equipment well known to those skilled in the art.

The network further includes a supplier computer system 20 that can be located at the supplier site, e.g., a one time use vapor deposition source manufacturing site. The supplier computer system 20 includes a CPU motherboard 21. The CPU motherboard executes software stored on a hard drive 22. The CPU motherboard is coupled to a display monitor 23, keyboard 24 and a mouse 25, each of which permits the supplier 2 to readily communicate with the CPU motherboard 21. Other data drives such as a CD drive 26 and floppy drive 27 can be used to store data that can be accessed by the CPU motherboard 21. The supplier computer system 10 is also provided with a network interface 18 for communicating with the Internet 30, for example, by a dial-in modem or a broadband connection.

The user and supplier can communicate with each other using their respective computer systems and the Internet.

The network also includes the user's financial institution 40 and the supplier's financial institution 50, each of which is also in communication with the Internet 30 via the necessary computer systems. Payment for one time use vapor deposition sources can be made by transferring funds from the user's account at the user's financial institution 40 to the supplier's account at the supplier's financial institution 50 via the Internet 30. Typically, such a transaction would be done by request of the user to the user's financial institution via the Internet.

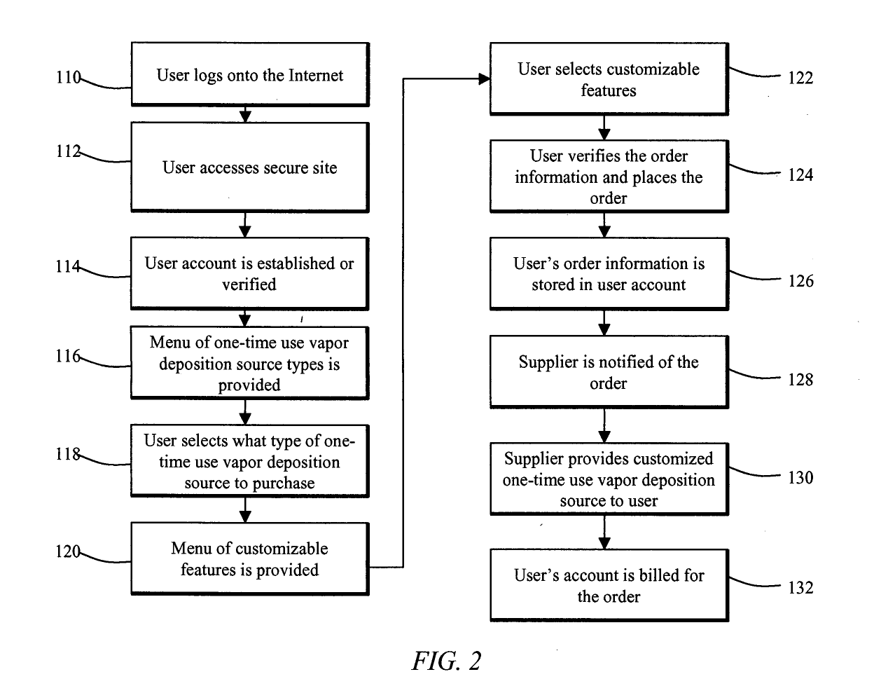

Turning now to FIG. 2, a flow diagram shows a typical purchase transaction for ordering a one time use vapor deposition source. In block 110, a user logs onto the Internet. In block 112, the user accesses a secure site, the contents of which are maintained by the supplier. The secure site is normally password protected. The password can be established by the user upon the user's first visit to the secure site. The Internet site can also have a non-secure portion for general information and browsing, but to place an order, a secure portion is normally required. In block 114, the user inputs information such as name, address, billing information and the like thereby establishing a user account with the supplier. Once an account has been established, this information does not have to be input again, but the user has the opportunity to verify and edit the account information.

In block 116, the user accesses a menu of information regarding the types one time use vapor deposition sources available or needed. In this menu, a user can input information regarding the type of vapor deposition source required. The term “type of vapor deposition source” refers to the physical aspects of the vapor deposition equipment being used. Such information can include manufacturer, model number, vapor deposition source dimensions, aperture plate to substrate spacing, or other information that will permit a supplier to select the proper boat, heating element, and an aperture plate that will be compatible with the user's vapor deposition equipment. Based on this information, the supplier, or a computer program available at the supplier's Internet site, can provide a short list of types of one time use vapor deposition sources for the user to select from. Alternatively, the user can select the type of vapor deposition source from a menu or a list without inputting information. In block 118, the user makes a selection regarding the type of one time use vapor deposition source and the quantity of each.

In block 120, the user accesses a menu of information regarding customizable features. Customizable feature information refers to product and manufacturing attributes that are desired. These can include choice of organic material(s) for deposition, desired thickness of the deposited layer, number of devices to be coated, vapor deposition rate, layer thickness uniformity, charge lifetime (minimum length of time that the one time use vapor deposition source should operate), and the like. Based on this information, the supplier, or a computer program available at the supplier's Internet site, can provide a short list of appropriate customizable features for the user to select from. Alternatively, the user can select the customizable features (e.g., type of material and quantity) from a menu or a list without inputting other information. In block 122, the user selects the customizable features.

Although not shown in FIG. 2, based on the customizable feature information, the supplier or a computer program at the supplier's Internet site can optionally loop back to block 116 and suggest a better type of one time use vapor deposition source. In addition, the user can be given the option to go back to block 116 to order a different one time use vapor deposition source with different customizable features. In an OLED system, for example, the user might order a one time use vapor deposition source(s) used to form a hole transporting layer and a different one time use vapor deposition source(s) used to form a light-emitting layer. This can all be included in a single purchase order.

In block 124, the selections made by the user are summarized for the user to review. The user verifies the selections are correct and places the order, for example, by clicking on an “order” button shown on the monitor. Optionally, additional information can be supplied at this point that can be included in the order, such as the date when the one time use vapor deposition source is needed. In block 126, the order information is stored in the user's account with the supplier. This information can be accessed by the user for future orders in order to save time. In block 128, the supplier is notified of the order, for example, by an automated email.

In block 130, the supplier provides the one time use vapor deposition source to the user. The supplier can manufacture the one time use source and ship it to the user. Alternatively, the supplier can contract a third party to manufacture the one time use source, and the third party can ship it to either the supplier or to the user. Because of the need for vapor deposition equipment and organic chemicals, it is quite possible that several different companies will participate in the manufacturing of the one time use vapor deposition source. Regardless of how many parties are involved and other details, the supplier took the order and is ultimately responsible for providing the one time use vapor deposition source to the user.

In block 132, the user's account is billed for the order. The bill can be an email to the user. The user then authorizes payment by the user's financial institution to the supplier's financial institution, for example, via the Internet. Alternatively, the bill can go directly from the supplier to the user's financial institution.

The foregoing is just one embodiment of how a one time use vapor deposition source can be ordered and paid for. There are many other possible embodiments. For example, the payment can occur before the source is provided to the user. Some information from block 116 can be included in block 120, or vice versa. Blocks 116 and 120 can be compressed into a single block. The order selection process can be done by telephone, by mail, or by some other communication network. It can also be done using in-person meetings between the user and supplier.

In many cases, multiple organic materials need to be deposited in a single layer. In OLED systems, for example, there can be two hosts and an emitting dopant. Often, this is accomplished by co-vapor deposition from multiple sources. Thus, a user can order multiple one time use vapor deposition sources that are optimized for codeposition. They can be designed to have similar charge lifetime.

After the one time use vapor deposition source has been spent, the user can send it back to the supplier or a supplier's designee. The supplier or designee refurbishes the one time use vapor deposition source or refurbishes parts of the vapor deposition source for use in a new one time use vapor deposition source. This lowers the manufacturing costs for the supplier, and that savings can be passed along to the user. The user can be given a monetary credit when a spent one time use vapor deposition source is returned. It is especially useful to refurbish the heating element because it is often the most expensive portion of the one time use vapor deposition source equipment. Refurbishment typically involves cleaning the part(s), e.g. treating with a cleaning solution or solvent, baking to drive off impurities, plasma treatments, or the like. In some cases, a test can be performed to ensure that the part(s) is in proper working order. Residual organic materials can also be recovered, purified, and reused.

Vapor Deposition Source and Equipment

One skilled in the art will understand that there are many different types of vapor deposition sources and associated equipment that can be used in this invention. So-called point sources and linear sources are two common types. Some non-limiting examples of vapor deposition sources and equipment are described in U.S. Pat. Nos. 6,237,529, 6,507,698, 6,582,523, U.S. Patent Application Publications 2003/0015140 A1, 2004/0144321 A1, 2003/168013 A1, 2003/0047817 A1, 2002/0192499 A1, 2001/0006827 A1, and WO 01/31081 A1. The one time use vapor deposition source of this invention has at least a boat for containing an organic material to be vaporized, a heater for causing vaporization, and an aperture plate to control the distribution of the vapor.

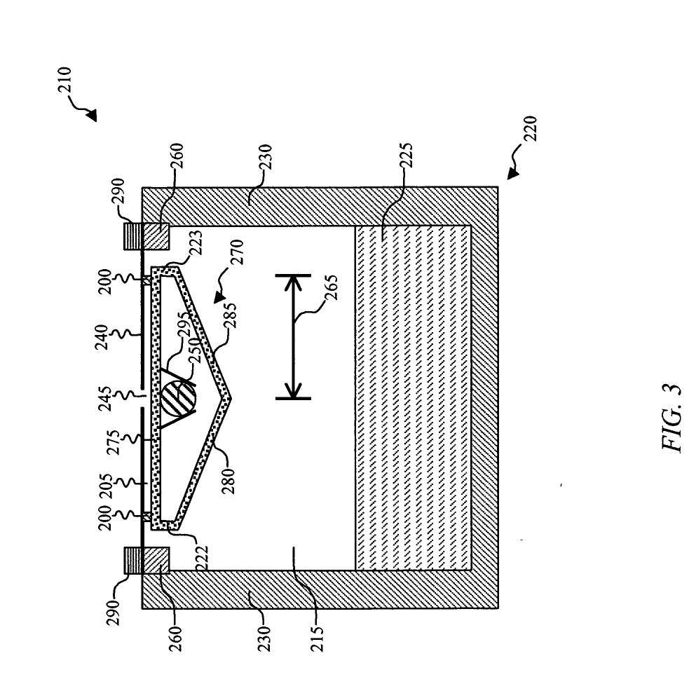

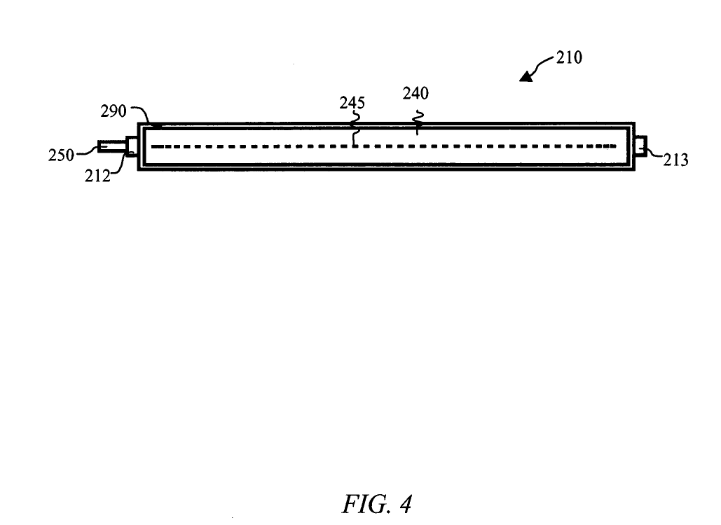

Although some or all of the parts can be refurbished and reused, it is useful to keep the cost of such a one time vapor deposition source to a minimum. One example of a low cost, one time use vapor deposition source is shown in FIGS. 3-4. Many other variations will be evident to one skilled in the art.

Turning now to FIG. 3, there is shown a cross-sectional view of a one time use vapor deposition source for depositing organic material in accordance with this invention. One time use vapor deposition source 210 includes a boat 220 having a cavity 215 for holding a charge of organic material 225 and can be sealed as will be seen. Organic material 225 provided in cavity 215 is commonly material that is solid at room temperature and will be further detailed below. A top portion 260 can be attached to boat 220 by various ways, or can be an integral part of boat 220, e.g., by being cast or molded as a single structure.

One time use vapor deposition source 210 includes an aperture plate 240 that has a plurality of spaced apertures 245. Aperture plate 240 is designed to emulate boat 220 so as to make a leak free seal. Various ways for making airtight seals can be used. For example, clamping means 290 can hold aperture plate 240 in place via the use of bolts to top portion 260. A gasket, for example made out of graphite foil, can be provided between aperture plate 240 and top portion 260, or between aperture plate 240 and clamping means 290, or both. Other sealing means are also possible. For example, aperture plate 240 can be attached to and sealed with top portion 260 by such ways as swaging, crimping, screwing with a flange and gasket, or welding to form a leak free seal.

Both boat 220 and aperture plate 240 can be constructed from a variety of materials. For structural stability and the ability to withstand the high temperatures necessary to vaporize organic material 225, metals such as stainless steel, molybdenum, titanium, gold, platinum, and tantalum are particularly useful.

One time use vapor deposition source 210 further includes a heating element 250, which is provided in cavity 215 between aperture plate 240 and organic material 225. Heating element 250 traverses the length of one time use vapor deposition source 210. It can be a solid piece of resistive metal through which current is passed and can be connected to a power supply (not shown) at each exposed end. Alternatively, heating element 250 can be a cartridge heater where insulated resistive wiring is encased in a tube and wire leads (not shown) are connected to a power supply.

Baffle member 270 traverses the length of one time use vapor deposition source 210 and is provided in a predetermined spaced relationship to aperture plate 240 and spaced from boat 220. Baffle member 270 is in contact with and encloses heating element 250. Heating element 250 is supported at the ends of boat 220, as will be seen, and can support baffle member 270. Baffle member 270 can optionally include guides 295 at intervals along its length so as to better position the baffle member within the one time use vapor deposition source. Baffle member 270 can comprise metals such as stainless steel, molybdenum, titanium, gold, platinum, and tantalum. Also useful are exterior surface coatings and treatments that increase the infrared emissivity of baffle member 270. Coatings include, e.g. a carbon-black layer, while surface treatments include a matte surface. Such coatings and treatments are well known to those skilled in the art.

The periphery of baffle member 270 is triangular or substantially triangular, that is, it defines at least three surfaces, e.g. first surface 275, second surface 280, and third surface 285, that surround heating element 250 so as to absorb infrared energy from the heating element and redirect that energy. Baffle member 270 can also include additional surfaces, e.g. surfaces 222 and 223, if required by the geometry of the device or for simplifying the construction of baffle member 270. Such additional surfaces are not required for this invention and the actual configuration of baffle member 270 will be determined in part by the geometry of boat 220. First surface 275 of baffle member 270 is in contact with heating element 250 and is disposed in parallel relation to aperture plate 240 in a predetermined spaced relationship, thus forming vapor path 205 between baffle member 270 and aperture plate 240. To reduce variations in the conductance of the organic vapor in one time use vapor deposition source 210 to achieve uniformity of vapor emission, the ratio of the length of vapor path 205, represented by distance 265, to the width of the vapor path is selected to be at least 10:1 so as to reduce variations in pressure in one time use vapor deposition source 210. However, those skilled in the art will realize that a number of factors determine the conductance of organic vapor within boat 220 and through vapor path 205 and aperture 245. The conductance ratio can be determined as described in commonly assigned U.S. patent application Ser. No. 10/352,558 filed Jan. 28, 2003, by Jeremy M. Grace, et al., entitled “Method of Designing a Thermal Physical Vapor Deposition System”, the disclosure of which is herein incorporated by reference, to adjust size of boat 220 and apertures 245, and the size and position of baffle member 270, to produce the desired vapor uniformity and emission rate. Baffle member 270 can include stand-offs 200 in predetermined locations, e.g. near the corners of baffle member 270, to help maintain the position of the baffle member and the predetermined spaced relationship with aperture plate 240. Second and third portions of baffle member 270 define an additional two surfaces, that is second surface 280 and third surface 285, respectively, that are spaced from heating element 240.

Baffle member 270 and its surfaces are disposed to absorb infrared energy from heating element 250 and constructed to redirect such infrared energy. First surface 275 will redirect the infrared energy to aperture plate 240 and thus prevent condensation of organic material and plugging of apertures 245. Second and third surfaces 280 and 285, respectively, are arranged to redirect infrared energy to opposing sides of organic material 225, thus providing more even distribution of the energy and preventing preferential vaporization of organic material 225 in the center, and to boat walls 230, thus preventing condensation of vaporized organic material on the walls.

Baffle member 270 can optionally have some holes in it to adjust vapor production and to permit the passage of solid organic material if needed, e.g., so that organic material does not become trapped in the baffle during shipment.

Turning now to FIG. 4, there is shown a top view of the above one time use vapor deposition source 210. Open-ended collar 212 and closed-ended collar 213 serve to support heating element 250, and therefore also support baffle member 270 as described above. Collars 212 and 213 can be made of an electrically insulating material. If heating element 250 is a solid piece of resistive metal, then collars 212 and 213 should be electrically insulating. Preferably, the collars also produce an effective seal between heating element 250 and boat 220 so that vapor does not escape by this path. Aperture plate 240 has a series of apertures 245 along its length for release of organic material vapors from one time use vapor deposition source 210. Apertures 245 can be of a uniform size and spacing in the center of the aperture distribution. However, to maintain uniform coating over the entire length of aperture plate 240, it is necessary to adjust the size or spacing, or both, of the apertures at the ends, as described in commonly assigned U.S. patent application Ser. No. 10/971,698 filed Oct. 25, 2004, by Dennis R. Freeman, et al., entitled “Elongated Thermal Physical Vapor Deposition Source With Plural Apertures” (a continuation-in-part of U.S. patent application Ser. No. 10/093,739 filed Mar. 8, 2002, now abandoned).

When assembling the one time use vapor deposition source, all of the various parts should be clean and dry. Cleaning solutions, acids, bases, or solvents can be used as necessary to ensure the source parts are free of contaminants. It is useful to bake the parts before assembling to remove surface water. For many organic materials, it is advantageous to assemble the source under inert atmosphere conditions, e.g., in a glove box.

Organic Materials

Any organic material capable of vapor deposition can be used in this invention. Organic materials useful for making OLED devices are particularly envisioned (see below).

The organic material is provided into the boat in the appropriate amount. The organic material can be a single type of material or a mixture of multiple materials. If a mixture, it is advantageous if they both have similar vapor pressure properties. The organic material can be provided as a powder, as granules, tablets, or other convenient form. If provided as a powder or as granules, the organic material can be compacted (e.g., with heat and pressure) in the boat in order to form a large solid mass. When its physical properties permit, the organic material can be melted and provided into the boat as a liquid and then permitted to resolidify. Alternatively, when its physical properties permit, the organic material can be dissolved in a low boiling solvent and provided into the boat as a liquid solution, and then permitted to recrystallize upon evaporation of the solvent. The tablets, compacted materials, resolidified and recrystallized materials can be advantaged relative to powders and granules because they have a higher density. This can increase the useful lifetime of the one time use vapor deposition source. When the organic material is formed in one or a few large-sized pieces, they can be held in place by tabs, pins, or other mechanisms. Powders, on the other hand, can shift during shipping. The customer can move the powder back into the bottom of the boat by some tipping and gentle shaking. Although this should not be problematic, having organic material that stays in place is advantaged.

After the one time use vapor deposition source has been assembled, it should be packaged in an inert atmosphere, preferably with a desiccant or getter. Tape or some other removable material should be placed over the aperture holes. This will prevent powder from spilling out during shipping and will provide additional protection of the organic materials from contamination as well as maintaining the internal inert atmosphere (e.g. argon or nitrogen) of the boat. The tape can optionally contain a desiccant or a getter. In one embodiment, the one time use vapor deposition source (with apertures covered) is placed in a labeled foil bag along with CaO desiccant, and the bag is sealed. The bag and the source are then placed in a metal box along with any shock absorbing material desired such as foam, plastic beads. The metal box should also be capable of forming an effective seal. The metal box is also labeled and shipped.

A general structure for an OLED device can include, in sequence, anode/hole-injecting layer/hole-transporting layer/light-emitting layer/electron-transporting layer/cathode. The organic materials suitable for this invention are typically the ones between the anode and cathode. A non-limiting set of example materials that can be used to fabricate various layers of an OLED device include the following.

Hole-Injecting Layer (HIL)

It is often useful to provide a hole-injecting layer between the anode and hole-transporting layer. The hole-injecting material can serve to improve the film formation property of subsequent organic layers and to facilitate injection of holes into the hole-transporting layer. Suitable materials for use in the hole-injecting layer include, but are not limited to, porphyrinic compounds as described in U.S. Pat. No. 4,720,432 and some aromatic amines, for example, m-MTDATA (4,4′,4″-tris[(3-methylphenyl)phenylamino]triphenylamine.

Hole-Transporting Layer (HTL)

The hole-transporting layer contains at least one hole-transporting compound such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel, et al. U.S. Pat. No. 3,180,730. Other suitable triarylamines substituted with one or more vinyl radicals and/or comprising at least one active hydrogen containing group are disclosed by Brantley, et al. U.S. Pat. Nos. 3,567,450 and 3,658,520.

A more preferred class of aromatic tertiary amines are those which include at least two aromatic tertiary amine moieties as described in U.S. Pat. Nos. 4,720,432 and 5,061,569. The hole-transporting layer can be formed of a single or a mixture of aromatic tertiary amine compounds. Illustrative of useful aromatic tertiary amines are the following:

1,1-Bis(4-di-p-tolylaminophenyl)cyclohexane;

1,1-Bis(4-di-p-tolylaminophenyl)-4-phenylcyclohexane;

N,N,N′,N′-tetraphenyl-4,4′″-diamino-1,1′:4′,1″:4″,1′″-quaterphenyl;

Bis(4-dimethylamino-2-methylphenyl)phenylmethane;

1,4-bis[2-[4-[N,N-di(p-toly)amino]phenyl]vinyl]benzene (BDTAPVB);

N,N,N′,N′-Tetra-p-tolyl-4,4′-diaminobiphenyl;

N,N,N′,N′-Tetraphenyl-4,4′-diaminobiphenyl;

N,N,N′,N′-tetra-1-naphthyl-4,4′-diaminobiphenyl;

N,N,N′,N′-tetra-2-naphthyl-4,4′-diaminobiphenyl;

N-Phenylcarbazole;

4,4′-Bis[N-(1-naphthyl)-N-phenylamino]biphenyl (NPB);

4,4′-Bis[N-(1-naphthyl)-N-(2-naphthyl)amino]biphenyl (TNB);

4,4′-Bis[N-(1-naphthyl)-N-phenylamino]p-terphenyl;

4,4′-Bis[N-(2-naphthyl)-N-phenylamino]biphenyl;

4,4′-Bis[N-(3-acenaphthenyl)-N-phenylamino]biphenyl;

1,5-Bis[N-(1-naphthyl)-N-phenylamino]naphthalene;

4,4′-Bis[N-(9-anthryl)-N-phenylamino]biphenyl;

4,4′-Bis[N-(1-anthryl)-N-phenylamino]-p-terphenyl;

4,4′-Bis[N-(2-phenanthryl)-N-phenylamino]biphenyl;

4,4′-Bis[N-(8-fluoranthenyl)-N-phenylamino]biphenyl;

4,4′-Bis[N-(2-pyrenyl)-N-phenylamino]biphenyl;

4,4′-Bis[N-(2-naphthacenyl)-N-phenylamino]biphenyl;

4,4′-Bis[N-(2-perylenyl)-N-phenylamino]biphenyl;

4,4′-Bis[N-(1-coronenyl)-N-phenylamino]biphenyl;

2,6-Bis(di-p-tolylamino)naphthalene;

2,6-Bis[di-(1-naphthyl)amino]naphthalene;

2,6-Bis[N-(1-naphthyl)-N-(2-naphthyl)amino]naphthalene;

N,N,N′,N′-Tetra(2-naphthyl)-4,4″-diamino-p-terphenyl;

4,4′-Bis{N-phenyl-N-[4-(1-naphthyl)-phenyl]amino}biphenyl;

2,6-Bis[N,N-di(2-naphthyl)amino]fluorene;

4,4′,4″-tris[(3-methylphenyl)phenylamino]triphenylamine (MTDATA); and

4,4′-Bis[N-(3-methylphenyl)-N-phenylamino]biphenyl (TPD).

Another class of useful hole-transporting materials includes polycyclic aromatic compounds as described in EP 1 009 041. Some hole-injecting materials described in EP 0 891 121 A1 and EP 1 029 909 A1, can also make useful hole-transporting materials.

Light-Emitting Layer (LEL)

As more fully described in U.S. Pat. Nos. 4,769,292 and 5,935,721, each of the light-emitting layers (LEL) of the organic EL element include a luminescent fluorescent or phosphorescent material where electroluminescence is produced as a result of electron-hole pair recombination in this region. The light-emitting layer can be comprised of a single material, but more commonly contains a host material doped with a guest emitting material or materials where light emission comes primarily from the emitting materials and can be of any color. This guest emitting material is often referred to as a light emitting dopant. The host materials in the light-emitting layer can be an electron-transporting material, as defined below, a hole-transporting material, as defined above, or another material or combination of materials that support hole-electron recombination. The emitting material is typically chosen from highly fluorescent dyes and phosphorescent compounds, e.g., transition metal complexes as described in WO 98/55561, WO 00/18851, WO 00/57676, and WO 00/70655. Emitting materials are typically incorporated at 0.01 to 10% by weight of the host material.

An important relationship for choosing an emitting material is a comparison of the bandgap potential which is defined as the energy difference between the highest occupied molecular orbital and the lowest unoccupied molecular orbital of the molecule. For efficient energy transfer from the host to the emitting material, a necessary condition is that the band gap of the dopant is smaller than that of the host material. For phosphorescent emitters (including materials that emit from a triplet excited state, i.e., so-called “triplet emitters”) it is also important that the host triplet energy level of the host be high enough to enable energy transfer from host to emitting material.

Host and emitting materials known to be of use include, but are not limited to, those disclosed in U.S. Pat. Nos. 4,768,292, 5,141,671, 5,150,006, 5,151,629, 5,405,709, 5,484,922, 5,593,788, 5,645,948, 5,683,823, 5,755,999, 5,928,802, 5,935,720, 5,935,721, 6,020,078, 6,475,648, 6,534,199, 6,661,023, U.S. Patent Application Publications 2002/0127427 A1, 2003/0198829 A1, 2003/0203234 A1, 2003/0224202 A1, and 2004/0001969 A1.

Metal complexes of 8-hydroxyquinoline (oxine) and similar derivatives constitute one class of useful host compounds capable of supporting electroluminescence. Illustrative of useful chelated oxinoid compounds are the following:

CO-1: Aluminum trisoxine [alias, tris(8-quinolinolato)aluminum(III)];

CO-2: Magnesium bisoxine [alias, bis(8-quinolinolato)magnesium(II)];

CO-3: Bis[benzo{f}-8-quinolinolato]zinc(II);

CO-4: Bis(2-methyl-8-quinolinolato)aluminum(III)-μ-oxo-bis(2-methyl-8-quinolinolato)aluminum(III);

CO-5: Indium trisoxine [alias, tris(8-quinolinolato)indium];

CO-6: Aluminum tris(5-methyloxine) [alias, tris(5-methyl-8-quinolinolato)aluminum(III)];

CO-7: Lithium oxine [alias, (8-quinolinolato)lithium(I)];

CO-8: Gallium oxine [alias, tris(8-quinolinolato)gallium(III)]; and

CO-9: Zirconium oxine [alias, tetra(8-quinolinolato)zirconium(IV)].

Another class of useful host materials includes derivatives of anthracene, such as those described in U.S. Pat. Nos. 5,935,721, 5,972,247, 6,465,115, 6,534,199, 6,713,192, U.S. Patent Application Publications 2002/0048687 A1, 2003/0072966 A1, and WO 2004/018587. Some examples include derivatives of 9,10-dinaphthylanthracene derivatives and 9-naphthyl-10-phenylanthracene. Other useful classes of host materials include distyrylarylene derivatives as described in U.S. Pat. No. 5,121,029, and benzazole derivatives, for example, 2,2′,2″-(1,3,5-phenylene)tris[1-phenyl-1H-benzimidazole].

Desirable host materials are capable of forming a continuous film. The light-emitting layer can contain more than one host material in order to improve the device's film morphology, electrical properties, light emission efficiency, and lifetime. Mixtures of electron-transporting and hole-transporting materials are known as useful hosts. In addition, mixtures of the above listed host materials with hole-transporting or electron-transporting materials can make suitable hosts.

Useful fluorescent dopants include, but are not limited to, derivatives of anthracene, tetracene, xanthene, perylene, rubrene, coumarin, rhodamine, and quinacridone, dicyanomethylenepyran compounds, thiopyran compounds, polymethine compounds, pyrylium and thiapyrylium compounds, fluorene derivatives, periflanthene derivatives, indenoperylene derivatives, bis(azinyl)amine boron compounds, bis(azinyl)methane boron compounds, derivatives of distryrylbenzene and distyrylbiphenyl, and carbostyryl compounds. Among derivatives of distyrylbenzene, particularly useful are those substituted with diarylamino groups, informally known as distyrylamines.

Suitable host materials for phosphorescent emitters (including materials that emit from a triplet excited state, i.e., so-called “triplet emitters”) should be selected so that the triplet exciton can be transferred efficiently from the host material to the phosphorescent material. For this transfer to occur, it is a highly desirable condition that the excited state energy of the phosphorescent material be lower than the difference in energy between the lowest triplet state and the ground state of the host. However, the band gap of the host should not be chosen so large as to cause an unacceptable increase in the drive voltage of the OLED. Suitable host materials are described in WO 00/70655 A2; WO 01/39234 A2; WO 01/93642 A1; WO 02/074015 A2; WO 02/15645 A1, and U.S. Patent Application Publication 2002/0117662 A1. Suitable hosts include certain aryl amines, triazoles, indoles and carbazole compounds. Examples of desirable hosts are 4,4′-N,N′-dicarbazole-biphenyl (CBP), 2,2′-dimethyl-4,4′-N,N′-dicarbazole-biphenyl, m-(N,N′-dicarbazole)benzene, and poly(N-vinylcarbazole), including their derivatives.

Examples of useful phosphorescent materials that can be used in light-emitting layers of this invention include, but are not limited to, those described in WO 00/57676, WO 00/70655, WO 01/41512 A1, WO 02/15645 A1, WO 01/93642 A1, WO 01/39234 A2, WO 02/071813 A1, WO 02/074015 A2, U.S. Pat. Nos. 6,458,475, 6,573,651, 6,451,455, 6,413,656, 6,515,298, 6,451,415, 6,097,147, U.S. Patent Application Publications 2003/0017361 A1, 2002/0197511 A1, 2003/0072964 A1, 2003/0068528 A1, 2003/0124381 A1, 2003/0059646 A1, 2003/0054198 A1, 2002/0100906 A1, 2003/0068526 A1, 2003/0068535 A1, 2003/0141809 A1, 2003/0040627 A1, 2002/0121638 A1, EP 1 239 526 A2, EP 1 238 981 A2, EP 1 244 155 A2, JP 2003073387A, JP 2003073388A, JP 2003059667A, and JP 2003073665A.

Electron-Transporting Layer (ETL)

Preferred thin film-forming materials for use in forming the electron-transporting layer of the organic EL elements of this invention are metal chelated oxinoid compounds, including chelates of oxine itself (also commonly referred to as 8-quinolinol or 8-hydroxyquinoline). Such compounds help to inject and transport electrons, exhibit high levels of performance, and are readily fabricated in the form of thin films. Exemplary oxinoid compounds were listed previously.

Other electron-transporting materials include various butadiene derivatives as disclosed in U.S. Pat. No. 4,356,429 and various heterocyclic optical brighteners as described in U.S. Pat. No. 4,539,507. Benzazoles and triazines are also useful electron-transporting materials.

The invention has been described in detail with particular reference to certain preferred embodiments thereof, but it will be understood that variations and modifications can be effected within the spirit and scope of the invention.

### PARTS LIST

1 user
2 supplier
10 user computer system
11 CPU motherboard
12 hard drive
13 display monitor
14 keyboard
15 mouse
16 CD drive
17 floppy drive
18 network interface
20 supplier computer system
21 CPU motherboard
22 hard drive
23 display monitor
24 keyboard
25 mouse
26 CD drive
27 floppy drive
28 network interface
30 Internet
40 user's financial institution
50 supplier's financial institution
110 block
112 block
114 block
116 block
118 block
120 block
122 block
124 block
126 block
128 block
130 block
132 block
200 stand-off
205 vapor path
210 vapor deposition source
212 open-ended collar
213 closed-ended collar
215 cavity
220 boat
222 surface
223 surface
225 organic material
230 boat wall
240 aperture plate
245 aperture
250 heating element
260 top portion
265 distance
270 baffle member
275 first surface
280 second surface
285 third surface
290 clamping means
295 guide

1. A method of providing a customized one time use vapor deposition source to a user, comprising:
a) a supplier receiving an order from the user;
b) the supplier providing the one time use vapor deposition source to the user, wherein the one time use vapor deposition source includes at least a boat containing the organic material, a heating element, and an aperture plate; and
c) the supplier receiving payment for the one time use vapor deposition source.

2. The method according to claim 1 wherein the supplier receives the order over a communication network.

3. The method according to claim 2 wherein the communication network includes the Internet, and the supplier and user both access the Internet through a computer system.

4. The method according to claim 2 wherein the payment is made via the communication network.

5. The method according to claim 3 wherein the payment is made via the Internet.

6. The method according to claim 1 further including:
d) the supplier or supplier's designee receiving a spent one time use vapor deposition source from the user, wherein the supplier or designee refurbishes such one time use vapor deposition source or refurbishes parts of the vapor deposition source for use in a new one time use vapor deposition source.

7. The method according to claim 1 further including the supplier providing a plurality of one time use vapor deposition sources, each one for use in the same device manufacturing process so that two or more organic materials can be codeposited.

8. The method according to claim 1 wherein the order includes information regarding the type of organic material to be deposited, the amount of such material required, the minimum length of time that the one time use vapor deposition source should operate, vacuum system equipment in which the one time use vapor deposition source is used, aperture plate to substrate spacing, or the date when the one time use vapor deposition source is needed, or combinations thereof.

9. The method according to claim 6 wherein the refurbishing includes cleaning, testing, and reusing the heating element.

10. The method according to claim 1 wherein the one time use vapor deposition source supplied to the user is packaged in a container under inert atmosphere conditions and the container is sealed.

11. The method according to claim 10 wherein the container contains a getter or desiccant.

12. The method according to claim 10 wherein the user returns the spent one time use vapor deposition source to the supplier in the container.
